(19) United States
(12) Patent Application Publication
(10) Pub. No.: US 2008/0137075 A1
(43) Pub. Date: Jun. 12, 2008

(54) Inspection method of magnetic head slider and inspection device thereof

(75) Inventors: Ryujii Fujii, Hong Kong (CN); Yoshikazu Sato, Ichikawa city (JP)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 12/000,052

(22) Filed: Dec. 7, 2007

(30) Foreign Application Priority Data
Dec. 12, 2006 (JP) 2006-334355

(51) Int. Cl. G01N 21/00

(52) U.S. Cl. 356/73

(57) ABSTRACT

The present invention relates to a method for inspecting a slider, wherein the state of the slider is one in which a row bar is not yet diced into sliders, the row bar including a plurality of rectangular sliders which are aligned in a longitudinal direction of the row bar. The method of the present invention comprises: a holding step for holding the row bar such that both a first normal vector that extends from a first side of the slider and a second normal vector that extends from a second side of the slider have upward components with regard to a vertical direction, wherein the first normal vector and the second normal vector are two normal vectors among four normal vectors that extend from four sides of the slider, the four sides not facing an adjacent slider; and an inspection step for optically inspecting the first and second sides of the slider of the row bar by means of first and second inspection means, respectively, the row bar being held.

The present application is based on, and claims priority from, J.P. Application No. 2006-334355, filed Dec. 12, 2006, the disclosure of which is hereby incorporated by reference herein in its entirety.

### BACKGROUND OF THE INVENTION

1. Field of the Invention

The present invention relates to a method and an apparatus for inspecting a slider, and in particular relates to a method for optically inspecting a slider in the state of a row bar.

2. Description of the Related Art

A slider is manufactured by forming a read/write element on a ceramic wafer, such as an Al—TiC wafer, by means of the thin film technology, then by dicing the wafer into row bars such that a side that is to be formed into an air bearing surface appears in the longitudinal direction thereof, and then by dicing the row bar into individual sliders. When read/write elements are formed on a wafer, ID (identification) numbers of the sliders are written on the film surface of the wafer, thereby enabling management of sliders and row bars. Sliders are subjected to visual inspection several times using an optical microscope or the like when they are in the state of a row bar after they are separated from a wafer in the dicing process. If no inspection is performed before the final step in which a slider is incorporated in a head gimbal assembly (HGA), then a significant reduction in yield may occur, and effective investigation is impossible. Therefore, it is significantly important to inspect a slider in the state of a row bar in order to acquire information about fraction defective of the production lot in each step and to reflect it in the investigation of the reasons for defects and how to make improvement in each of these steps.

Visual inspection is mainly performed in order to check for the adhesion of dust and to detect locations of chippings on the air bearing surface or on the surface that is to be formed into the air bearing surface by means of lapping (hereinafter referred to as a first side). However, since the slider ID number is written on the film surface, simultaneous inspection of the film surface is required when the first side is inspected. In addition, the slider ID number must be confirmed in each step because of the requirement of process control of the row bar. Therefore, inspection is performed more frequently on the film surface than on the first side. The slider ID number is confirmed by a microscope. Two kinds of numbers, which are the wafer number and the slider ID number, are required to identify a slider. The wafer number is often written on a side that is opposite to the film surface (the back side of a wafer). In this case, three sides including the first side need to be inspected by a microscope. It should be noted that, in the present specification, the inspection of a slider includes not only the inspection of the first side etc., but also confirmation of the slider ID numbers and wafer numbers.

Row bars, which are highly fragile, are usually held in a case or in a tray in order to store and transfer them. FIG. 1 shows an example of a conventional tray. Tray 121 is formed of a frame to simultaneously house a plurality of row bars. Stepped portions 123 are provided on opposite sides of the tray to allow row bar B to be held by stepped portions 123. Since the slider ID number is frequently confirmed, as described above, row bar B is held such that the film surface, on which the slider ID number is written, faces upward to facilitate visual confirmation of the slider ID number.

When the visual inspection of the first side is performed, the row bar is held in the tray, and the slider ID number is confirmed first by means of an optical microscope. When the wafer number is written on the back side of the wafer, the tray is turned upside down to confirm the wafer number. Next, the row bars are picked up one by one from the tray using tweezers, and are then transferred to an inspection stand that is provided with an optical microscope to inspect the first side. However, the quality and efficiency of the inspection largely depends on the skill of the operator (the skill of setting a row bar, inspection time, and so on), and accordingly, significantly varies among operators. The operation of picking up a row bar, inspecting it and returning it to the tray requires high-level skill and experience because of the fragility of row bars. Consequently, operational errors, which lead to failure or contamination of a row bar, frequently occur, thereby causing a reduction in yield and an increase in inspection time. When a defect is found on the first side, the row bar is often turned 90 degrees to confirm the slider ID number again in order to identify the slider. Thus, an increase in defective sliders causes an increase in inspection time. In order to shorten the inspection time, the number of operators must be increased.

In order to solve such problems, efforts have been exerted so far to rationalize the method for inspecting a slider. Japanese Patent Laid-Open Publication No. 1993-223534 discloses a method for inspecting a slider from more than one direction. Specifically, many sliders are fixed on an outer surface of a rotating support. Orientation of the sliders is changed by the rotation of the support, and visual inspection can be performed using a fixed camera. According to this patent document, sliders may be fixed to a tape in advance, and the tape may be wrapped around a support.

Japanese Patent Laid-Open Publication No. 2002-048716 discloses a method for simultaneously inspecting more than one surface of a slider by means of a mirror. Specifically, a mirror is disposed at an angle of 45 degrees on a side of a slider that is to be inspected. By arranging the mirror within the view of an optical microscope, the image of a slider which is reflected on the mirror, as well as the image of the slider itself, comes into the view of the optical microscope, thereby allowing both the front and lateral sides of the slider to be simultaneously inspected.

The prior art disclosed in the patent documents mentioned above is disadvantageous due to low operational efficiency, because sliders which are separated from a row bar, which is separated from a wafer, must be mounted on a special-purpose supporting tool. If an adhesive is used to mount the sliders on the supporting tool, then the adhesive may remain on the sliders, which may affect reliability of the sliders. In addition, according to these methods, inspection of a slider in the state of a row bar is impossible.

### SUMMARY OF THE INVENTION

An object of the present invention is to provide a method and an apparatus for performing visual inspection of a slider in an efficient manner while limiting influence on the slider.

According to one embodiment of the present invention, a method for inspecting a slider, wherein the state of the slider is one in which a row bar is not yet diced into sliders, the row bar including a plurality of rectangular sliders which are aligned in a longitudinal direction of the row bar is provided. The method of the present invention comprises: a holding step for holding the row bar such that both a first normal vector that extends from a first side of the slider and a second normal vector that extends from a second side of the slider have upward components with regard to a vertical direction, wherein the first normal vector and the second normal vector are two normal vectors among four normal vectors that extend from four sides of the slider, the four sides not facing an adjacent slider; and an inspection step for optically inspecting the first and second sides of the slider of the row bar by means of first and second inspection means, respectively, the row bar being held.

In this way, since the row bar is held such that two sides of the row bar simultaneously face upward, the two sides can be simultaneously inspected from different directions by means of different inspecting means, thereby enabling efficient inspection. Since it is not necessary to handle the row bar with physical means, such as tweezers, in order to inspect the two sides, and because the sliders can be inspected while they are held in a tray, the influence to the sliders can be minimized.

The inspecting step may comprise moving a tray which holds the row bar in the longitudinal direction after inspecting the first and second sides of one of the sliders of the row bar, and inspecting the first and the second sides of another one of the sliders.

The holding step may comprise holding a plurality of the row bars on a tray such that positions of longitudinal axes of the row bars are obtained by mutual translation of the longitudinal axes; and the inspecting step comprises moving the tray in a direction that is perpendicular to the longitudinal direction after inspecting one of the row bars, and inspecting another one of the row bars.

The inspecting step may comprise moving the first and second inspection means in the longitudinal direction after inspecting the first and second sides of one of the sliders of the row bar, and inspecting the first and the second sides of another one of the sliders.

The holding step may comprise holding a plurality of the row bars such that positions of longitudinal axes of the row bars are obtained by mutual translation of the longitudinal axes; and the inspecting step comprises moving the first and the second inspection means in a direction that is perpendicular to the longitudinal direction after inspecting one of the row bars, and inspecting another one of the row bars.

The first inspection means may be provided on a line of the first normal vector; and the second inspection means may be provided on a line of the second normal vector.

According to another embodiment of the present invention, an apparatus for inspecting a slider wherein the state of the slider is one in which a row bar is not yet diced into sliders, the row bar including a plurality of rectangular sliders which are aligned in a longitudinal direction of the row bar is provided. The apparatus comprises: a tray for holding the row bar such that both a first normal vector that extends from a first side of the slider and a second normal vector that extends from a second side of the slider have upward components with regard to a vertical direction, wherein the first normal vector and the second normal vector are two normal vectors among four normal vectors that extend from four sides of the slider, the four sides not facing an adjacent slider; and a first inspection means that is provided on a line of the first normal vector; and a second inspection means that is provided on a line of the second normal vector.

By using the apparatus of the present invention, the method for inspecting a slider described above can be preferably performed.

As described above, according to the present invention, a method and an apparatus for performing visual inspection of a slider in an efficient manner while limiting influence on the slider can be provided.

The above and other objects, features and advantages of the present invention will become apparent from the following description with reference to the accompanying drawings which illustrate examples of the present invention.

### BRIEF DESCRIPTION OF THE DRAWINGS

FIG. 1 is a perspective view of an exemplary conventional tray;

FIG. 2 is a general schematic view of an apparatus for inspecting a slider according to the present invention;

FIG. 3 is a sectional view of the apparatus for inspecting a slider cut along 2-2 line in FIG. 2;

FIG. 4 is a partial enlarged view of portion A in FIG. 3;

FIG. 5 is a plan view of the apparatus for inspecting a slider viewed from 4-4 line in FIG. 2;

FIG. 6 is a flow chart of a method for inspecting a slider according to the present invention; and

FIG. 7 is a conceptual view of images that are captured by each camera and that are displayed on an image display apparatus.

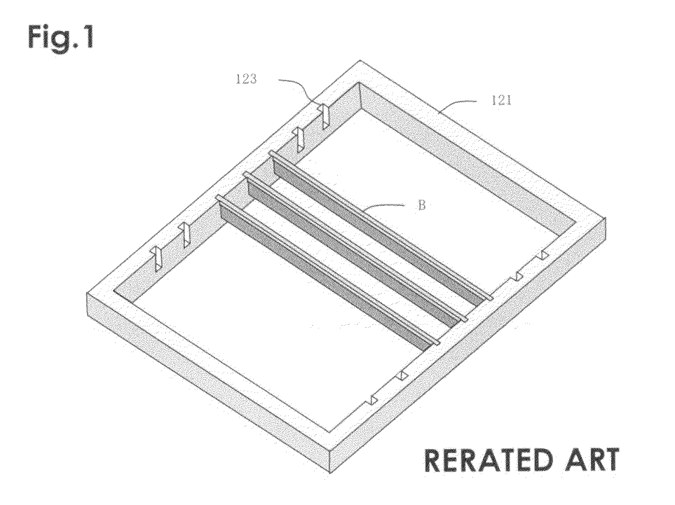

### DETAILED DESCRIPTION OF THE INVENTION

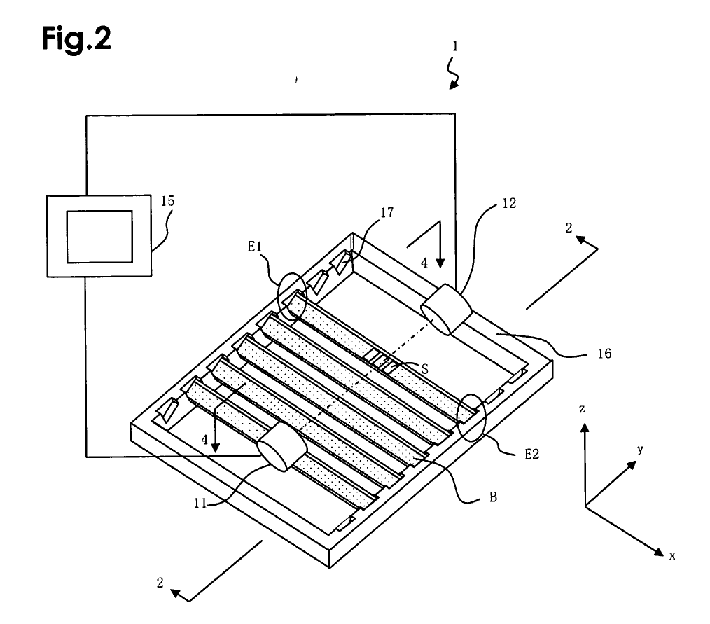

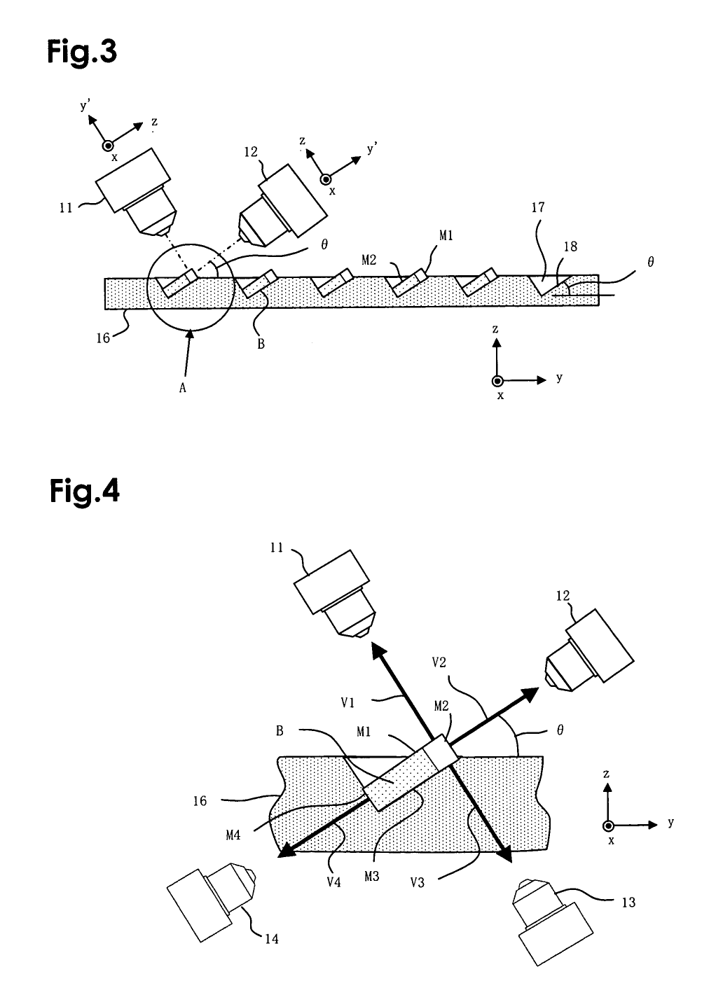

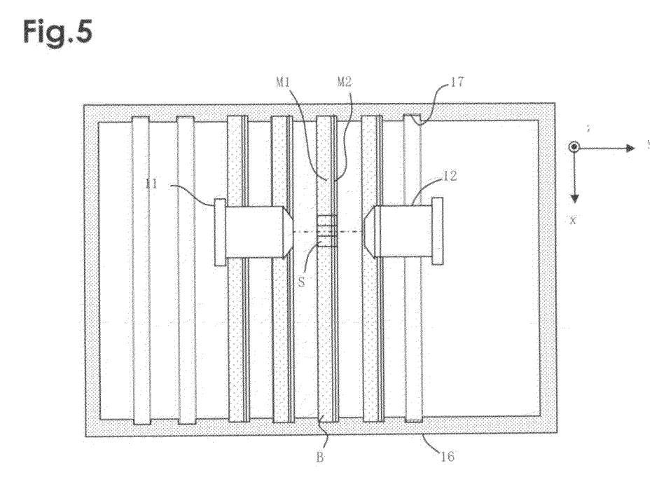

First, an apparatus for inspecting a slider according to an embodiment of the present invention will be described with reference to the drawings. FIG. 2 is a general schematic view of an apparatus for inspecting a slider according to an embodiment. FIG. 3 is a sectional view of the apparatus for inspecting a slider cut along 2-2 line in FIG. 2. FIG. 4 is a partial enlarged view of portion A in FIG. 3. FIG. 5 is a plan view of the apparatus for inspecting a slider viewed from 4-4 line in FIG. 2. In each drawing, a row bar is held on a tray.

With reference to FIG. 2, tray 16 is comprised of a frame having an aperture. A plurality of stepped portions 17 are provided on both sides that are opposite to each other. The frame is made of plastic that contains carbon in order to avoid electrostatic discharge of the sliders. If space can be secured for row bar B, then tray 16 may be provided with a bottom plate, not shown. Stepped portion 17 has contact surface 18 that is inclined at angle θ with respect to the horizontal direction, as illustrated in FIG. 3. Through engagement with contact surface 18 of ends E1, E2, row bar B is supported on tray 16. Angle θ of contact surface 18 can be selected, for example, from between 30° and 60°. The depth of stepped portions 17 is set such that the upper end of row bar B is located above tray 16 when row bar B is placed on tray 16, so that cameras 11, 12, which will be described later, can be prevented from colliding with tray 16. Tray 16 may be configured to fix row bar B by vacuum chucking.

Tray 16 can hold a plurality of row bars B such that row bars B are arranged in parallel to each other. The distance between row bars B can be properly set such that cameras 11, 12 are prevented from coming into contact with adjacent row bar B due to an operational error.

Tray 16 also functions as a storage means for row bars B. Tray 16 is used independently for most of the time in the process of manufacturing sliders, and is only incorporated into apparatus 1 when visual inspection of the sliders is required.

Tray 16 can be moved in longitudinal direction x of row bar B, lateral direction y of row bar B and vertical direction z by means of transfer means, not shown.

Row bar B includes a plurality of rectangular sliders S which are aligned in longitudinal direction x. Accordingly, each slider S has four visible sides M1 to M4 and two invisible sides which face adjacent sliders S. Row bar B is supported by stepped portions 17 at both ends thereof with regard to the longitudinal direction x such that four sides M1 to M4 of slider S are located in the aperture of tray 16 in a visible state. With reference to FIG. 4, first side M1 is the air bearing surface of slider S or the surface that is to be formed into the air bearing surface (the surface which has not been subjected to lapping). Second side M2 is the film surface of a wafer (the top surface of the films that are deposited on a wafer). Third side M3 is the back side of the air bearing surface. Fourth side M4 is the back side of the film surface of the wafer.

Now, four normal vectors V1 to V4 that extend outwardly from four sides M1 to M4, respectively, are assumed, as illustrated in FIG. 4. First normal vector V1 extends from first side M1. Second vector V2 extends from second side M2. Second normal vector V2 is inclined at angle θ with respect to the horizontal plane. Third normal vector V3 extends from third side M3. Fourth normal vector V4 extends from fourth side M4. When row bar B is placed on tray 16 in the orientation shown in FIG. 4, first normal vector V1 and second normal vector V2 have upward components with regard to the vertical direction. Therefore, the air bearing surface and the film surface of slider S can be simultaneously observed while row bar B is held in tray 16, as described below.

First camera 11 is provided on the line of first normal vector V1. First camera 11 is adapted to take images of first side M1 (the air bearing surface) of slider S. First camera 11 has two switchable magnifications, i.e., 200-power and 500-power, so that the entire area of first side M1 of a slider and the area in the vicinity of the element (the pole) can be inspected at proper magnifications, respectively.

Second camera 12 is provided on the line of second normal vector V2. Second camera 12 is adapted to take images of second side M2 (the film surface) of slider S. Second camera 12 has a magnification of 200-power so that the entire area of second side M2 of a slider can be inspected.

First camera 11 and second camera 12 may be, for example, but are not be limited to, a digital camera having a CCD (Charge-Coupled Device). Any optical inspection means, such as a microscope, can also be used. First camera 11 is not necessarily required to be positioned on the line of first normal vector V1, and the position thereof may be deviated from first normal vector V1, as long as images of first side M1 can be properly taken. The same applies to second camera 12. The magnification is not limited to the values mentioned above, and may also be variable. First camera 11 and second camera 12 can be moved in longitudinal direction x of row bar B, in direction y′ which is along the optical axis of the camera, and in direction z′ which is perpendicular both to direction x and to direction y′ by means of transfer means, which are not shown. By moving the camera in direction y′ along the optical axis of the camera, the focus of the camera can be adjusted. It should be noted that the coordinate system x-y′-z′ depends on cameras 11, 12. Direction y′ and direction y form angle θ in case of camera 12, whereas direction y′ and direction z forms angle θ in case of camera 11.

Cameras 11, 12 are connected to image display apparatus 15. Image display apparatus 15 is capable of simultaneously displaying data, which are obtained by cameras 11, 12, by using technique, such as screen partitioning. Also, cameras 11, 12 and image display apparatus 15 can be connected to a computer for image processing and image display, not shown.

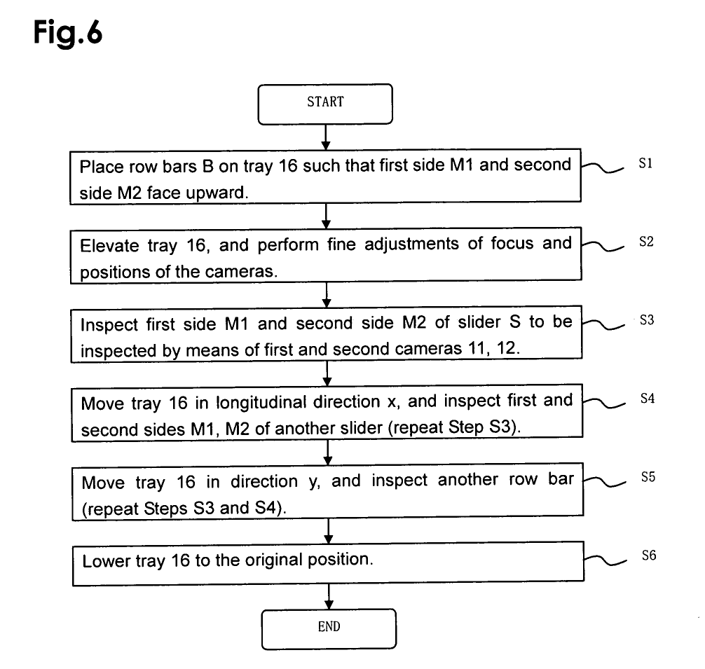

Next, a method for inspecting a slider that uses the inspection apparatus described above will be described with reference to a flow chart shown in FIG. 6.

(Step S1) First, a plurality of row bars B, which are separated from a wafer, are placed on tray 16 such that first side M1 and second side M2 face upward, as illustrated in FIG. 4. As described above, row bar B is an assembly of a plurality of sliders S which are aligned in longitudinal direction x. The slider has an approximately rectangular parallelepiped shape that is provided with first side M1, which is the air bearing surface or the surface that is to be formed into the air bearing surface by means of lapping, on one side. The plurality of row bars B are supported by tray 16 such that positions of the longitudinal axes (the central axes of row bars B that extend in direction x) of row bars B are obtained by mutual translation of row bars B.

(Step S2) In this state, tray 16 is elevated by means of transfer means. Tray 16 is stopped at a position that enables first camera 11 and second camera 12 to take images of first side M1 and second side M2, respectively. After tray 16 is stopped, first camera 11 and/or second camera 12 may be moved in direction y′ in order to adjust the focus thereof. In addition, first camera 11 and/or second camera 12 may also be moved in directions x and z′ to perform fine adjustment of the position for taking images.

(Step S3) First side M1 and second side M2 of slider S that is to be inspected are optically inspected by means of first and second cameras 11, 12. First camera 11 obtains the complete images of first side M1 and partial enlarged images of first side M1 in the vicinity of the pole by automatically or manually switching the magnifications. The presence of scratches and contamination on first side M1 can be inspected by observing the complete images. The area in the vicinity of the pole is particularly important from the viewpoint of the function of the slider, and therefore, requires inspection at a large magnification. By switching the magnifications and thereafter by taking images of the proper area, more accurate inspection is possible. Simultaneously with taking images of first side M1 by first camera 11, second camera 12 obtains the complete images of second side M2. Second side M2 is the film surface on which a slider ID number is written. Since the film surface is provided with bonding pads, not shown, and contamination and chippings are likely to be problematic after washing, there is a large need for inspection. The wafer ID number may also be written on this side. It should be appreciated that “simultaneously” obtaining images or “simultaneously” performing inspection does not mean performing these operations strictly simultaneously, and that these operations may be performed with some time lag.

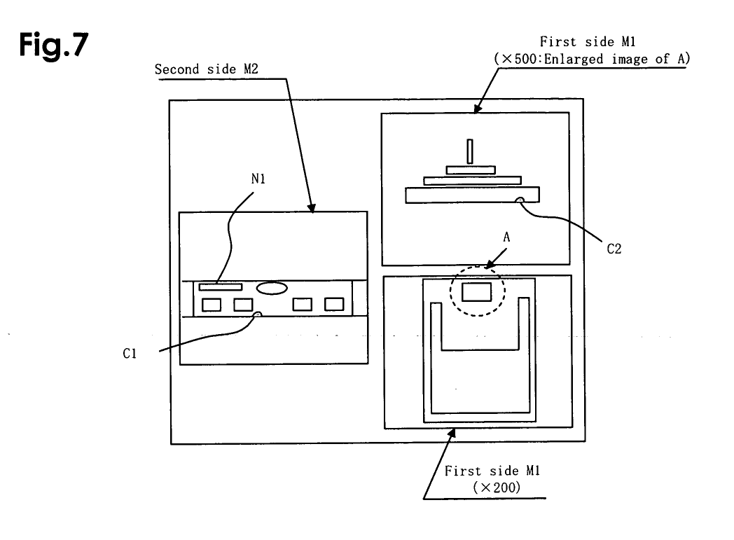

FIG. 7 is a conceptual view of images that are captured by each camera and that are displayed on an image display apparatus. The screen of image display apparatus 15 is divided into three sections. An complete image of first side M1 (lower right), an enlarged image (upper right) of the area in the vicinity of the pole (portion A in the drawing) and an complete image of second side M2 (left), all of which are described above, are simultaneously displayed on respective sections. Since defects C1, C2, such as chippings, are simultaneously displayed and slider number N1 is also simultaneously displayed, detection of defects and identification of the row bar or the slider are facilitated. Instead of simultaneously displaying three images, each image may be sequentially displayed on the entire screen. Alternatively, two images selected may be simultaneously displayed.

(Step S4) When the inspection of first and second sides M1, M2 of a slider is completed, tray 16 is moved in longitudinal direction x, and first and second sides M1, M2 of another slider is inspected in the same manner as in Step S3.

(Step S5) When the inspection of a row bar is completed, tray 16 is moved in direction y and another row bar is inspected by repeating steps S3 and S4.

(Step S6) When the inspection of all row bars is completed, tray 16 is lowered to the original position.

In the inspection method described above, sliders are switched for the inspection mainly by the movement of tray 16, but sliders can also be switched by the movement of cameras 11, 12. Specifically, when the inspection of first and second sides M1, M2 of a slider of row bar B is completed, first and second cameras 11, 12 may be moved in longitudinal direction x so that first and second sides M1, M2 of another slider can be inspected. Similarly, row bars can also be switched for the inspection by the movement of cameras 11, 12. Specifically, when inspection on a row bar is completed, first and second cameras 11, 12 may be moved in direction y so that another row bar can be inspected. In this case, the movement in direction y is achieved by the combination of the movement in direction y′ and the movement in direction z′.

In the inspection method mentioned above, a method of simultaneously observing the air bearing surface and the film surface is described. However, a third side can also be simultaneously observed. For example, a wafer number may be written on third side M3, which is the back side of a wafer (the back side of the film surface). In this case, the following two methods are possible.

In the first method, a tray is turned upside down. Specifically, a tray that is in the state of FIG. 2 is turned upside down. In this case, measures are preferably taken to prevent row bars from dropping from the tray. Specifically, it is desirable to put a cover on row bars after they are placed on the tray in order to prevent the row bars from dropping from the tray. Alternatively, row bars may be fixed firmly to stepped portions 17 by means of appropriate measures, such as vacuum chucking described above.

In the second method, a third camera is provided beneath the tray. Specifically, as illustrated by the dashed lines in FIG. 4, third camera 13 is provided on the line of third normal vector V3 that extends from third side M3, and third side M3 is inspected by third camera 13, thereby allowing first to third sides M1 to M3 of slider S to be simultaneously inspected by the three cameras. Moreover, if fourth camera 14 is provided on the line of fourth normal vector V4 that extends from fourth side M4, then fourth side M4 of slider S can also be inspected. As a result, it is possible to simultaneously inspect first to fourth sides M1 to M4 by the four cameras. Third and fourth cameras 13, 14 are not necessarily required to be positioned on the lines of third and fourth normal vectors V3, V4, respectively, and the positions may be deviated from third and fourth normal vectors V3, V4, as long as images of third and fourth sides M3, M4 can be properly taken. Needless to say, image information about third and fourth sides M3, M4 can be simultaneously displayed on image display apparatus 15, as needed, in these cases. Attention should be paid to the requirement that tray 16 not be provided with a bottom plate when the second method is used.

As described above, according to the method and the apparatus for inspecting a slider of the present embodiment, more than one side of a slider can be simultaneously inspected in the state of a row bar in a highly efficient and reliable manner. Specifically, by holding a row bar on a tray in a slanted orientation, two sides of a slider can be simultaneously inspected, thereby reducing the possibility of damage to the slider, which may be caused to the air bearing surface due to contact with tweezers etc. during the inspection. Since the results of the inspection of more than one side are simultaneously displayed on the image display apparatus, a defective slider can be easily identified and working efficiency can also be improved. There may often be correlation between chippings and contamination on one side that is inspected and those on another side that is inspected. Since information about the inspection on more than one side is simultaneously displayed, analysis and investigation of cause are facilitated. Because of the improved working efficiency, the need to install many inspection apparatuses which are provided with optical microscopes is decreased, thereby contributing to a reduction in working space.

In addition, a row bar can be stored with the air bearing surface of a slider facing approximately upward in the present embodiment. Such a manner for storing a row bar is advantageous because the number of processes in which the air bearing surface of a slider faces upward is not small. Conventionally, giving priority to confirming slider ID numbers, which need to be frequently confirmed, a row bar is often stored with the film surface facing upward. However, the need to store a row bar with the film surface facing upward is reduced because the slider ID numbers written on the film surface can be easily identified in the present embodiment. This enables storing a row bar with the first side facing upward, and this is favorable for the manufacturing process.

Moreover, it is possible in the present invention to inspect a slider one by one, or to inspect sliders in the state of being aligned in a holder, as well as in the state of a bar.

Although certain preferred embodiments of the present invention have been shown and described in detail, it should be understood that various changes and modifications may be made without departing from the spirit or scope of the written claims.

What is claimed is:

1. A method for inspecting a slider, wherein the state of said slider is one in which a row bar is not yet diced into sliders, said row bar including a plurality of rectangular sliders which are aligned in a longitudinal direction of said row bar, comprising:
a holding step for holding said row bar such that both a first normal vector that extends from a first side of said slider and a second normal vector that extends from a second side of said slider have upward components with regard to a vertical direction, wherein said first normal vector and said second normal vector are two normal vectors among four normal vectors that extend from four sides of said slider, said four sides not facing an adjacent slider; and
an inspection step for optically inspecting said first and second sides of said slider of said row bar by means of first and second inspection means, respectively, said row bar being held.

2. The method according to claim 1, wherein said inspecting step comprises moving a tray which holds said row bar in the longitudinal direction after inspecting said first and second sides of one of said sliders of said row bar, and inspecting said first and said second sides of another one of said sliders.

3. The method according to claim 1, wherein
said holding step comprises holding a plurality of said row bars on a tray such that positions of longitudinal axes of said row bars are obtained by mutual translation of said longitudinal axes; and
said inspecting step comprises moving said tray in a direction that is perpendicular to said longitudinal direction after inspecting one of said row bars, and inspecting another one of said row bars.

4. The method according to claim 1, wherein said inspecting step comprises moving said first and second inspection means in the longitudinal direction after inspecting said first and second sides of one of said sliders of said row bar, and inspecting said first and said second sides of another one of said sliders.

5. The method according to claim 1, wherein:
said holding step comprises holding a plurality of said row bars such that positions of longitudinal axes of said row bars are obtained by mutual translation of said longitudinal axes; and
said inspecting step comprises moving said first and said second inspection means in a direction that is perpendicular to said longitudinal direction after inspecting one of said row bars, and inspecting another one of said row bars.

6. The method according to claim 1, wherein:
said first inspection means is provided on a line of said first normal vector; and
said second inspection means is provided on a line of said second normal vector.

7. The method according to claim 1, wherein said inspection step comprises inspecting a third side of said slider together with said first and second sides by means of a third inspection means, wherein said third inspection means is provided on a line of a third normal vector that extends from said third side of said slider.

8. The method according to claim 7, wherein said inspection step comprises inspecting a fourth side of said slider together with said first to third sides by means of a fourth inspection means, wherein said fourth inspection means is provided on a line of a fourth normal vector that extends from said fourth side of said slider.

9. The method according to claim 1, wherein said inspection step comprises simultaneously displaying states of said inspected sides of said row bar on an image display apparatus.

10. The method according to claim 1, wherein said first side of said row bar is an air bearing surface of said slider or a side that is to be formed into the air bearing surface of said slider.

11. An apparatus for inspecting a slider wherein the state of said slider is one in which a row bar is not yet diced into sliders, said row bar including a plurality of rectangular sliders which are aligned in a longitudinal direction of said row bar, comprising:
a tray for holding said row bar such that both a first normal vector that extends from a first side of said slider and a second normal vector that extends from a second side of said slider have upward components with regard to a vertical direction, wherein said first normal vector and said second normal vector are two normal vectors among four normal vectors that extend from four sides of said slider, said four sides not facing an adjacent slider; and
a first inspection means that is provided on a line of said first normal vector; and
a second inspection means that is provided on a line of said second normal vector.
